(19) United States
(12) Patent Application Publication
(10) Pub. No.: US 2004/0244356 A1
(43) Pub. Date: Dec. 9, 2004

(54) Thermal transpiration pump for gaseous material driven by chemical reaction

(76) Inventor: Paul David Ronney, Monrovia, CA (US)

Correspondence Address: PAUL RONNEY, 613 RANCHITO ROAD, MONROVIA, CA, 91016, US

(21) Appl. No.: 10/857,670

(22) Filed: May 29, 2004

Related U.S. Application Data
(60) Provisional application No. 60/474,554, filed on May 29, 2003.

(51) Int. Cl. F02K 1/00

(52) U.S. Cl. 60/200.1

(57) ABSTRACT

A gas pump comprising of a porous material or capillary tube(s) that uses a chemically reactive material added to the pumped gas for the purpose of generating, upon reaction, a temperature gradient across said porous material or capillary tube(s) and thereby sustaining the thermal transpiration pumping process without an external heat or cooling source is described. Means for coincident pumping of non-reacting gas streams, multiple-stage pumping for higher gas pressures, coincident electrical power generation, and ignition of the reactive material are presented.

### CROSS-REFERENCE TO RELATED APPLICATIONS

The present, application claims the benefit of U.S. Provisional Application Patent No. 60/474,554 filed May 29, 2003.

U.S. patent Documents

U.S. Pat. No. 6,533,554 B1 March 2003 Vargo et al.

Other Publications

W.-N. Shen, B. Dunn, F. Ragot, M. Goorsky, C. Moore, D. W. Song, G. Chen, R. Gronsky, T. Radetic, W. Fuller-Mora and A. Ehrlich, Proceedings of the 18^{th} International Conference on Thermoelectrics (IEEE, Piscataway, N.J.) pp. 562-564, 1999; W.-N. Shen, B. Dunn, C. D. Moore, M. S. Goorsky, T. Radetic and R. Gronsky, “Synthesis of nanoporous bismuth films by liquid-phase deposition,” Journal of Materials Chemistry, Volume 10, Issue 3, pp. 657-662, February 2000.

S. A. Lloyd and F. J. Weinberg, “A burner for mixtures of very low heat content,” Nature, Volume 251, pp. 47-49, 1974; S. A. Lloyd and F. J. Weinberg. “Limits to energy release and utilisation from chemical fuels,” Nature, Volume 257, pp. 367-370, 1975.

### BACKGROUND OF INVENTION

The present invention relates generally to the field of gas pumps, particularly a pump based on the thermal transpiration process in a porous material or narrow tube(s) that benefits from the addition of a chemically reactive material to the gas mixture being pumped for the purpose of generating, upon reaction, a temperature gradient across said porous material or tube(s) and thereby self-sustaining the thermal transpiration pumping process without an external heating or cooling source, supplemental working fluids, electrical power or moving parts.

Most prior art pumps for gaseous material require moving parts. The moving parts add to the size, weight, complexity and cost of said pumps and decrease the reliability of said pumps compared to a device having no moving parts. The use of pumps with moving parts is particularly problematic for small portable, mobile or hand-carried devices (for example, having typical dimensions less than 25 mm) which have large surface area to volume ratios because friction losses scale with surface area whereas pumping power scales with the volume of the device; thus, small pumps will have larger friction losses as a percentage of the electrical or mechanical power input than larger pumps. Small-scale pumps are essential components of many small portable, mobile or hand-carried systems such as Micro Electromechanical Systems (MEMS) devices, propulsion systems for unmanned miniature aircraft or spacecraft, “Lab-on-a-Chip” devices, microscale gas sampling instrumentation (for example, microscale gas chromatographs and mass spectrometers), miniature on-demand gas generators, microscale pneumatic accumulators for mechanical actuators, active cooling systems for dense microelectronic devices, and pressurization of fuel and air in devices converting fuels or other chemical reactants to electrical or mechanical power using combustion or fuel cells.

A process known to those of ordinary skill in the art of gas pumping is the thermal transpiration process, which occurs in porous material or narrow tube(s) to which a temperature gradient is applied (in the axial direction in the case of tube(s)) when the typical diameter of the pores or tube(s) is comparable to the mean free path of the gas molecules (for example, about 70 nanometers for air at ambient temperature and pressure.) Thermal transpiration causes simultaneously a flow and an increase in the gas pressure in the direction of increasing temperature within the porous material or tube(s) with no moving parts. Despite the advantage of no moving parts, pumps base on the thermal transpiration process have not seen substantial practical application because most porous materials or tube wall materials have a high thermal conductivity and thus the pumping efficiency, defined as the ratio of pumping power (the gas flow rate multiplied by the pressure rise across the pump) to the thermal power required to maintain the temperature gradient across the material, is small.

Recently Vargo et al. described a thermal transpiration pump using low thermal conductivity porous materials such as “aerogels” whose typical pore size is comparable to the mean free path of air molecules at ambient conditions. Vargo et al. describe an electrical resistive heater to supply the thermal power for the thermal transpiration process. However, for portable, mobile or hand-carried devices this electrical energy must either be stored in the form of batteries that have very low energy storage density per unit mass or volume, or said electrical energy must be converted from another higher energy density source such as fuel, but conversion of fuel to thermal energy to electrical energy for the purpose of generating thermal energy at a particular location on or in the porous material for the purpose of thermal transpiration is a very energy-inefficient process because of the low energy conversion efficiency of thermal, energy to electrical energy. This in turn means that a given quantity of fuel energy produces a much smaller quantity of thermal energy via electrical resistive heating on the higher temperature side of the porous material or tube(s) being used to cause the thermal transpiration pumping.

What is needed and what is provided by the current invention is a thermal transpiration pump that does not require electrical power, a supplemental heat flow path or a supplemental working fluid to deliver thermal energy to proper location on the tube(s) or porous material being used to cause the thermal transpiration pumping.

### BRIEF SUMMARY OF THE INVENTION

The current invention is a self-sustaining gas pump based on the process of thermal transpiration but instead of electrical heating as described by Vargo et al., the current invention uses thermal power generated by chemical reaction of reactants contained in or added to the gases being pumped. The advantage of using chemical energy rather than resistive electrical heating as the thermal source for thermal transpiration pumping is substantial. The efficiency of chemical to electrical energy conversion in portable power plants using ordinary hydrocarbon fuels burned with air is at most about 30%, even at large scales. For small scale devices (less than about 25 mm in dimension) there are no existing electrical power generation devices using fuels that can be reacted with ambient air as the energy storage medium. The primary means to provide electrical power at small scales is via batteries that (in the case of lithium-ion batteries) have an energy storage per unit mass of typically 100 watt-hours per kilogram compared to over 10,000 watt-hours per kilogram for hydrocarbon fuels burning in air. Therefore, using hydrocarbon fuels burning in air for thermal power generation in the thermal transpiration pump provides a factor of about 100 mass savings over using batteries for thermal power generation. Some pumping applications require more pressure than one stage of thermal transpiration pumping can provide; means to incorporate multiple stages of pumping into a thermal transpiration pumping device driven by chemical reaction are described. Some gas pumping applications cannot allow chemical reaction within the gaseous material being pumped; means to use the invention to pump gas streams that cannot allow chemical reaction are described. Some devices using gas pumps additionally require electrical power for electronic devices; means to incorporate electrical power generation into the thermal transpiration pump are described.

The term “pump” is used throughout this document to apply to devices that increase the pressure of a gas flowing through the device; this may include devices in which the inlet of gas is at ambient atmospheric pressure and the outlet is at a pressure higher than ambient atmospheric pressure (often called a “compressor”), devices in which the inlet of gas is below ambient atmospheric pressure and the outlet is at ambient atmospheric, pressure (often called a “vacuum pump,”) or devices in which neither the inlet nor outlet of gas is at ambient atmospheric pressure.

### BRIEF DESCRIPTION OF THE DRAWINGS

FIG. 1 is a schematic diagram of a single-stage, stand-alone single-stream thermal transpiration pumps with catalyst integrated into high-temperature thermal guard.

FIG. 2 is a schematic diagram of a single-stage, stand-alone single-stream thermal transpiration pump with catalyst integrated into high-temperature side of the transpiration membrane.

FIG. 3 shows an embodiment of the invention integrated into a spiral counter-current heat exchanger for the purpose of minimizing heat losses and thereby reduce the propensity for self-extinguishment of the exothermic chemical reaction.

FIG. 4 shows a multi-stage thermal transpiration pump integrated into a spiral counter-current heat exchanger.

FIG. 5 shows a detail of a preferred embodiment of the multi-stage thermal transpiration pump shown in FIG. 4.

FIG. 6 shows an embodiment of the invention for combined pumping of reacting gas supplying thermal energy to sustain transpiration in both a reacting gas stream and a non-reacting gas stream, with catalyst integrated into high-temperature thermal guard on the reactive stream.

FIG. 7 shows a combined thermal transpiration pumping and electrical power generation and device employing a porous thermoelectric material.

### DETAILED DESCRIPTION OF THE INVENTION

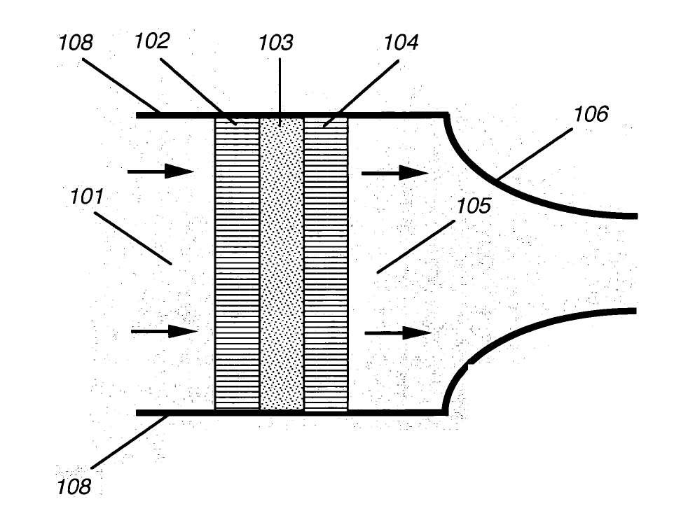

FIG. 1 shows the basic unit of the thermal transpiration pump driven by chemical reaction. The unreacted inlet gas 101 including fuel, air and/or other chemical reactant(s) that produces an exothermic (heat releasing) reaction first flows through a channel 108 whose height or diameter is preferably 1 to 25 mm to a low-temperature “thermal guard” 102 consisting of a plate with channels or pores whose diameters, preferably between 1 and 500 micrometers, are much larger than the mean free path of the gas molecules and thus are too large to cause any significant thermal transpiration. The material of the low-temperature thermal guard 102 preferably has the following properties: (a) thermal conductivity much larger than the material performing the thermal transpiration function, for example 2 to 400 W/m° C., and (b) is non-catalytic to the reactant(s) in the inlet gas 101. The gas then passes through a thermal transpiration membrane 103 made of porous material or tube(s) having pores or channels whose diameters are comparable to the mean free path of the gas molecules and thus provide thermal transpiration pumping. The preferred diameters are between 5 and 500 nanometers if the inlet gas 101 is at ambient atmospheric pressure that has a mean free path of about 70 nanometers. The material of the transpiration membrane 103 preferably has the following properties: (a) very low thermal conductivity, preferably less than 0.5 W/m° C., and (b) is non-catalytic to the reactant(s) in the inlet gas 101. A preferred material for the transpiration membrane is silica aerogel and a preferred thickness is from 0.1 to 5 millimeters. Vargo et al. teach other transpiration membrane materials such as packed beds of spherical particles that are also suitable for the present invention. The reactants then pass through a second high-temperature thermal guard 104 consisting of a plate with channels or pores whose diameters, preferably between 1 and 500 micrometers, are much larger than the mean free path of the gas molecules and thus are too large to cause any significant thermal transpiration. The high-temperature thermal guard preferably has the following properties: (a) thermal conductivity much larger than the material performing the thermal transpiration function, for example 1 to 400 W/m° C., and (b) is comprised of or is coated with material that is catalytic to one or more of the constituents in the inlet gas, resulting in chemical reaction and thus heat production. It is well known to those of ordinary skill in the art of catalysis that platinum catalyzes the reaction of hydrogen and/or hydrocarbon fuels with air and/or oxygen, and thereby is a suitable choice of catalytic material if the inlet stream 101 comprises hydrogen and/or hydrocarbon fuels with air and/or oxygen. The heat release on the high-temperature thermal guard 104 sustains the temperature gradient and thus the thermal transpiration pumping is self-sustaining. Since the catalyst surface is in contact with the outlet side of the porous material or capillary tube(s), chemical reaction and thus heat release occurs in a location that has lower thermal path resistance to the outlet side than the inlet side. This ensures that the temperature gradient is maintained in the direction corresponding to increasing temperature from inlet to outlet, and thus the flow of gas via thermal transpiration is from the inlet to outlet.

The outlet or exhaust gases 105 have higher pressure and temperature than the inlet gases 101. These exhaust gases may be expanded through an optional nozzle 106 until the gas pressure is near ambient pressure, resulting in larger gas velocity and thus larger momentum than the inlet gas stream. The difference between the momentum of the exhaust and inlet gases causes the pump structure to exert a net force, called “thrust,” on the pump support structure. This thrust can be used to propel a miniature air or space vehicle.

In an alternative embodiment the inlet gas 101 contains a material that undergoes an endothermic (heat absorbing) reaction, and the low-temperature thermal guard 102 rather than the high temperature thermal guard 104 is comprised of or coated with catalytic material. This embodiment has the same effect as the embodiment shown in FIG. 1, namely that of creating a temperature gradient in the thermal transpiration membrane such that temperature increases in the direction of flow, which thereby provides the thermal transpiration effect needed to obtain self-sustaining pumping.

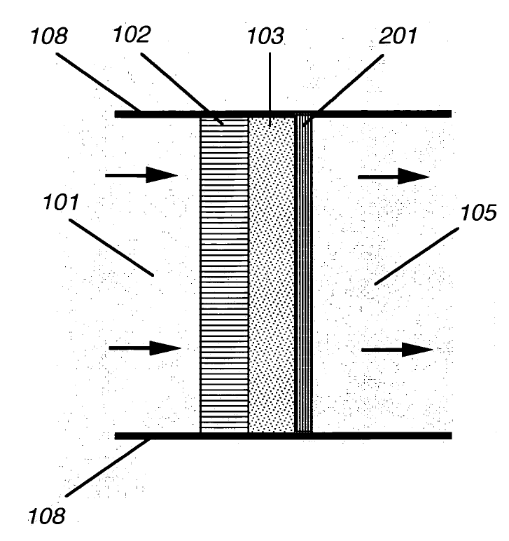

In another embodiment (FIG. 2) a catalytic material 201 is attached directly to the surface of the higher temperature side of the thermal transpiration membrane without the necessity for a high-temperature thermal guard 104 shown in FIG. 1, though said thermal guard may optionally be provided to minimize the variation in temperature over said surface. If the transpiration membrane is made of porous material such as an aerogel, said catalytic material may be patterned directly onto the membrane. It is well known to those of ordinary skill in the art of catalysis that metals with catalytic properties can be deposited in a layer 0.1 to 10 micrometers thick in a pattern on the surface of porous materials such as aerogels in a process called “metallization.” Because said metal layer blocks the exit of gas from the membrane, a pattern of holes in said metal layer is required to enable gas to escape from the thermal transpiration membrane. In order to provide a nearly uniform pattern of heating via chemical reaction on the surface of the membrane, a preferred pattern of holes is an array of generally square or circular holes that occupy between 20% and 80% of the area of the thermal transpiration membrane and whose hole width or diameter are at least ten times smaller than the thickness of the transpiration membrane. If the reactive material in the inlet gas contains hydrogen and/or hydrocarbon fuel and air and/or oxygen, a preferred catalyst material for this embodiment is platinum.

In an alternative embodiment the catalyst is composed of small particles deposited within the transpiration membrane. To establish and maintain a preferentially higher chemical reaction rate and thus higher temperature on the outlet side of the membrane, said particles are preferentially deposited in larger quantities closer to the outlet side of the membrane. If the reactive material in the inlet gas contains hydrogen and/or hydrocarbon fuel and air and/or oxygen, a preferred material for this embodiment is an aerogel seeded with particles of platinum of typical diameter 0.1 to 10 nanometers.

While FIG. 1 shows thermal guards attached to the low and high temperature sides of the thermal transpiration membrane, and FIG. 2 shows catalyst deposited on the high temperature side of the membrane, it will be obvious to those of ordinary skill in the art of heat transfer that many other configurations of thermal guards and/or catalyst placement will result in a increasing temperature across the membrane in the direction of gas flow through the membrane. The essential requirement for the current invention is that, in the case of gas streams containing exothermic reactants, the resistance to heat flow from the location of chemical reaction to the outlet side of the membrane is smaller than the resistance to the inlet side of the membrane so that the outlet side of the membrane remains hotter than the inlet side and thereby the process of thermal transpiration causes gas flow from the inlet side to the outlet side of the membrane. In the case of gas streams containing endothermic reactants, the corresponding requirement is that the resistance to heat flow from the location of chemical reaction to the inlet side of the membrane is smaller than the resistance to the outlet side of the membrane.

Miniature thermal systems, especially those requiring self-sustaining exothermic chemical reaction such as the present invention, may require, means to reduce heat losses to avoid self-extinguishment of the chemical reaction. Lloyd et al. showed that the propensity for self-extinguishment can be greatly reduced by employing a counter-current heat exchanger such that the reactants enter the through the lower temperature side of the heat exchanger, react and generate heat in a reactor situated between the exit of the lower temperature side of the heat exchanger and the inlet to the higher temperature side of the heat exchanger, and the reaction exhaust products exit through the higher temperature side of the heat exchanger. The exhaust products are hotter than the reactants due to the heat release associated with exothermic chemical reaction, thus, the hotter reaction products transfer a portion of their thermal enthalpy to the cooler reactants, which preheats the reactants without recirculating the reaction exhaust products themselves. Such devices are termed “excess enthalpy” burners because the thermal enthalpy of the incoming reactants is increased via preheating without diminishing the chemical enthalpy via chemical reaction, thus at the point within the device that chemical reaction occurs, the reactants have higher total enthalpy (sum of chemical plus thermal enthalpy) than the fresh reactants and thus, after reaction, will have a higher temperature than if the fresh reactants at ambient temperature were reacted without the benefit of pre-heating within the heat exchanger. This higher reaction temperature causes faster reaction rates and thereby enables self-sustaining exothermic chemical reaction under conditions of large heat losses and/or in reactive mixtures of low heating value that would not self-sustain reaction without heat recirculation.

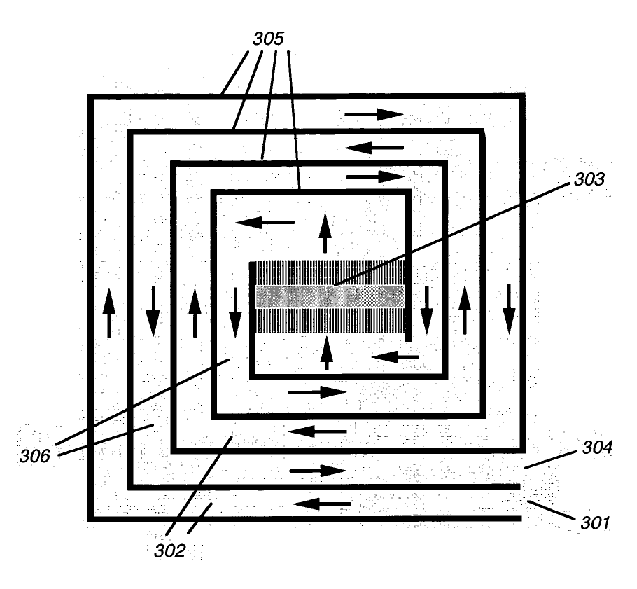

Lloyd et al. showed that performance of the counter-current heat exchanger and reactor benefits by rolling a linear counter-current exchanger into a generally spiral structure such that the reactant and product channels of the exchanger are interleaved and chemical reaction occurs generally in the center of the spiral. This benefit accrues because the interleaving creates additional surface area for heat exchange between the reactant and product channels, and because the external surface area exposed to ambient conditions is reduced, which reduces heat losses. FIG. 3 shows an embodiment of the current invention benefiting from said spiral counter-current heat exchanger. The reactive mixture 301 is drawn into the low-temperature (inlet) channel 302 by the action of the thermal transpiration pump 303 that is functionally identical to that shown in FIG. 1 or FIG. 2 and is located generally in the center of the spiral between the low-temperature reactant: (inlet) 302 and high-temperature exhaust (outlet) 306 channels of the heat exchanger. The reactive mixture 301 acquires thermal enthalpy from the product exhaust stream 304 via heat transfer across the dividing walls 305 of the heat exchanger. The reactive mixture is then drawn through thermal transpiration pump 303. Although the reactive mixture has a higher temperature at the inlet of the thermal transpiration pump 303 that at the inlet of the reactant (low-temperature) channel of the heat exchanger 302, the chemical reaction and thus heat production on the catalytic high-temperature thermal guard 104 causes an increase in temperature across the transpiration membrane 103 and thus maintains a temperature-gradient through the transpiration membrane 103 to sustain gas pumping via thermal transpiration from the inlet channel 302 to the outlet channel 303.

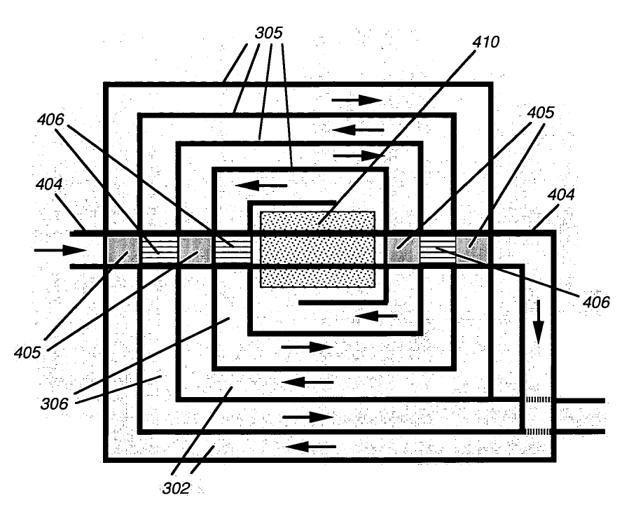

Some pumping applications require a higher pressure than that attainable from a single stage pump such as that shown in FIG. 1, FIG. 2, and FIG. 3. Vargo et al. teach a multi-stage thermal transpiration pump consisting of two or more stages in which transpiration stages in which the gas is heated are separated by cooling stages having pore or tube diameters much larger than the mean free path of the molecules so that the gas is cooled but no reverse thermal transpiration occurs in the cooling stages. In this way a larger pressure rise can be obtained than is possible from a single stage. FIG. 4 shows an embodiment of a multiple-stage thermal transpiration pump exploiting the temperature characteristics of the spiral counter-current heat exchanger described in FIG. 3. The gas temperature is higher in the exhaust (outlet) channels 306 than in either adjacent portion of the reactant (inlet) channels 302, consequently, a gas conduit 404 imbedded in the spiral counter-current heat exchanger traversing a path generally perpendicular to the channel walls 305 will experience alternating regions of increasing and decreasing temperature in the direction of flow through the conduit. By locating transpiration stages 405 in regions of increasing temperature in the direction of gas flow through the conduit 404 and cooling stages 406 in regions of decreasing temperature in the direction of gas flow through the conduit, the thermal profile experienced by the gas in said conduit 404 substantially follows that required for multiple-stage thermal transpiration pumping. The placement of transpiration and cooling stages are reversed for flow toward the center of the spiral compared to away from center of spiral so that for flow through the conduit 404 both toward and away from the center of the spiral, transpiration stages are present in regions of increasing temperature in the direction of gas flow through the conduit and cooling stages are present in regions of decreasing temperature in the direction of gas flow. One or more heat sources 410 located generally in the center of the spiral provide the thermal power required to maintain the temperature difference between the reactant (inlet) and exhaust (outlet) channels of the counter-current heat exchanger to sustain the temperature difference between the inlet and outlet streams. Said heat source(s) 410 may comprise an electrical resistive heater(s), conventional gas-phase reactor(s) for exothermic chemical reaction, a conventional catalytic reactor(s) for exothermic chemical reaction, a single-stage thermal transpiration pump of the type illustrated in FIG. 3, or a beneficial combination thereof.

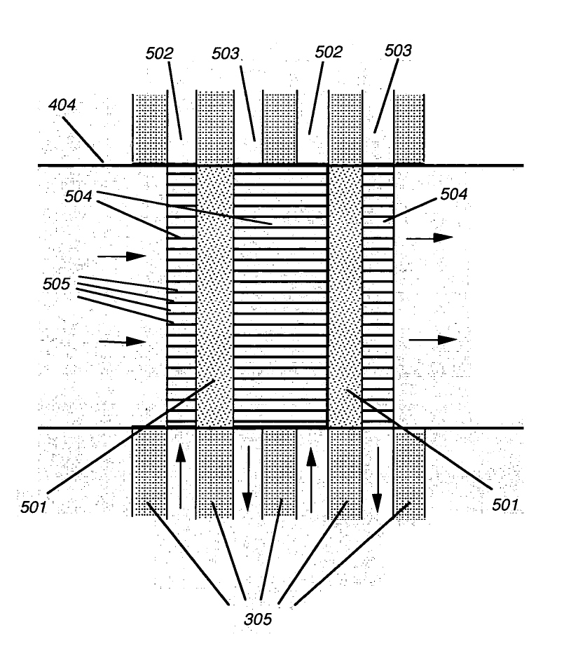

FIG. 5 shows a preferred embodiment of the transpiration and cooling stages embedded in the gas conduit within the spiral counter-current heat exchanger. Gas flows into the gas conduit 404, through one or more thermal transpiration membranes 501 generally located in regions where the conduit transitions between the cooler flow in the inlet channels 502 and the hotter flow in the outlet channels 503 of the counter-current heat exchanger, and through one or more cross-flow heat exchangers 504 generally located in regions where the conduit transitions between the hotter flow in the outlet channels 503 and the cooler flow in the inlet channels 502 of the counter-current heat exchanger. The cross-flow heat exchangers 504 are comprised of one or more tubes 505 through which the conduit gas flows and whose outer surfaces are exposed to the material flowing through the spiral counter-current heat exchanger in a direction generally perpendicular to the axis of the tubes. The tubes 505 have much larger diameters than the mean free path of the gas molecules and thus do not cause significant reverse thermal transpiration in the cooling stages.

While FIG. 4 shows an embodiment with a single gas stream that, after experiencing multiple stages of pumping, is then fed into the spiral counter-current heat exchanger and reactor, it will be obvious to those of ordinary skill in the art that the embodiment shown in FIG. 4 can be modified to include multiple gas streams of the same or different gases to obtain a larger total gas flow rate than that attainable from a single stream, or multiple passes of a single gas stream through the spiral counter-current heat exchanger to obtain a larger pressure than that attainable from a single pass, or a beneficial combination of multiple streams and multiple passes.

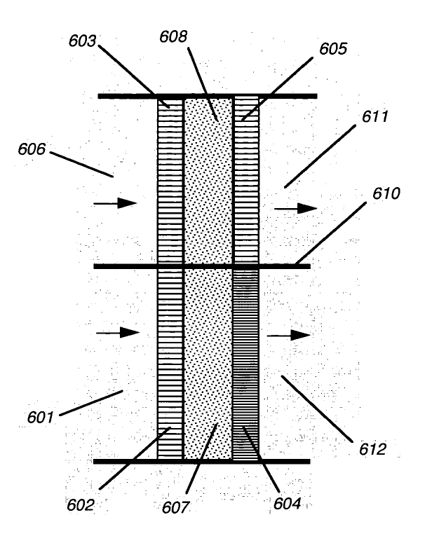

The devices shown in FIG. 1, FIG. 2, FIG. 3 and FIG. 4 are appropriate if the pumped gas can be seeded with one or more reactant(s). This is the case when the reactant gas, stream 101 itself needs to be pumped, for example when the reactant stream is the feedstock of a combustor or chemical reformer or the propulsive stream of a propulsion device for an air or space vehicle. In some applications of gas pumping, for example mass spectrometry or gas chromatography, however, this approach is unacceptable because the gas sample must be analyzed without altering its chemical composition. FIG. 6 shows an embodiment for combined pumping of a chemically reacting stream needed to sustain the temperature gradient for thermal transpiration in the chemically reacting stream as well one or more additional non-reacting streams. In the embodiment shown in FIG. 6, the reacting gas stream 601 and non-reacting gas stream 606 flow through non-catalytic low-temperature thermal guards 602, 603, then though thermal transpiration membranes 607, 608, then through high-temperature thermal guards 604, 605 comprised of a catalytic, chemically reacting portion 604 that is exposed to the reacting gas stream 601 and a non-catalytic, non-reacting portion 605 that is exposed to the non-reacting gas stream 606. The two gas streams 601, 606 are separated by a dividing wall or tube 610 that prevents gas exchange between the two streams. The dividing wall or tube 610 is preferably thin compared to the width of the high-temperature thermal guards 604, 605 in the direction perpendicular to the gas flow direction so that the thermal resistance between the two thermal guards is small compared to the thermal resistance of the transpiration membranes 607, 608. Heat is conducted, in the direction perpendicular to the gas flow direction, from the catalytic portion 604 to the non-reacting portion 605 of the high-temperature thermal guard, thereby inducing a higher temperature on the outlet side 611 of the non-reacting gas stream than the inlet side 601 and thereby a thermal transpiration effect in the non-reacting gas stream 606 in addition to the reacting gas stream 601 in addition to the thermal transpiration effect in the reacting gas stream 601 induced by the higher temperature on its outlet side 612. While FIG. 6 shows one reactive and one non-reactive gas stream, it will be obvious to those of ordinary skill in the art that the embodiment shown in FIG. 6 can be extended to include multiple non-reacting and/or reacting streams having substantial thermal communication between their high-temperature thermal guards.

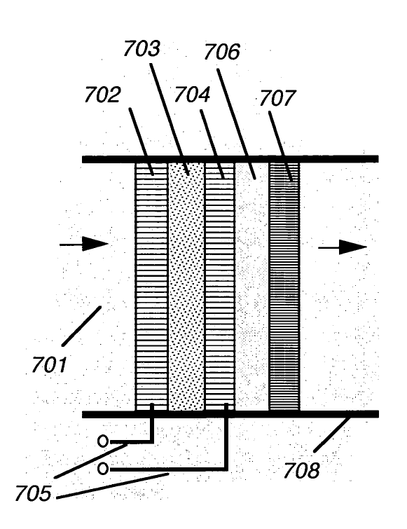

In many gas pumping applications, generation of electrical power is also required, for example microscale mass spectrometers or gas chromatographs. The configuration of FIG. 1 can be used to generate electrical power with no additional components if the thermal transpiration membrane is constructed from a material, commonly known as “thermoelectric material,” that produces an electrical current in the same or opposite direction as a temperature gradient applied across said material. Shen et al. have fabricated porous bismuth with typical pore diameter 5-10 nanometers and shown that this material possesses thermoelectric properties. Since the pore size is within the preferred range for thermal transpiration, such “nanoporous” bismuth can perform the dual functions of thermal transpiration and electrical power generation. Electrical power can be extracted from the, thermal guards of the device shown in FIG. 1 if both thermal guards are constructed from a material that is both electrically and thermally conductive, for example metals such as aluminum, copper or silver. Two disadvantages of this configuration are (a) bismuth has a relatively low melting point (about 270° C.) which limits the pumping performance since the maximum allowable temperature is low and (b) bismuth has relatively high thermal conductivity, about 0.4 W/m° C. according to Shen et al., compared to some preferred transpiration materials such as silica aerogels, which increases thermal power requirement for a given pumping power. FIG. 7 shows a preferred embodiment for electrical power generation within a “hybrid” single stage thermal transpiration pump. The inlet gas 701 first flows through a channel 708 to a non-catalytic low-temperature thermal guard 702 that preferably has the same properties as thermal guard 102 shown in FIG. 1 and additionally has the property of low electrical resistivity, preferably less than 1×10⁻⁶ ohm-m. The gas then passes through a porous thermal transpiration membrane 703 that is constructed of a thermoelectric material, preferably bismuth, and preferably has the same properties as thermal transpiration membrane 103 shown in FIG. 1 The reactants then pass through a second non-catalytic thermal guard 704 that preferably has the same properties as thermal guard 702. Electrical power is extracted from electrically conducting wires 705 connected to thermal guards 702 and 704. The reactants then pass through a second thermal transpiration membrane 706 that preferably has the same properties as thermal transpiration membrane 103 shown in FIG. 1 and finally through a third catalytic high-temperature thermal guard 707 that preferably has the same properties as thermal guard 104 shown in FIG. 1. The thicknesses of the transpiration membranes 703 and 706 are preferably chosen to distribute the temperature profile such that the temperature of the thermoelectric transpiration membrane 703 does not exceed the operability limit of the thermoelectric material, for example 270° C. in the case of bismuth.

It is well known to those of ordinary skill in the art of thermoelectric devices that the process of thermoelectric power generation can be reversed by applying an electrical current through the thermoelectric material with reverse polarity from that which the thermoelectric material generates in response to an applied temperature gradient. This current causes a temperature gradient to develop across the thermoelectric material in a process sometimes called the “Peltier effect.” This Peltier effect provides a means to accomplish pumping and ignition of the reactants passing through the device shown in FIG. 7 without additional parts. When an electrical current having the reverse polarity from that which the porous thermoelectric material 703 generates is passed through said material, the resulting temperature gradient established across said material will cause thermal transpiration pumping action that draws the inlet gases 701 into the device. Due to the Peltier effect, the thermoelectric material 703 acts as a heat pump and thus delivers more thermal energy at a given temperature to the outlet side of the transpiration membrane than would a purely resistive electrical heater, which reduces the electrical energy required to initiate chemical reaction compared to that required of a resistive electrical heater.

What is claimed as new is:

1. A pump for gaseous material comprising:
a thermal transpiration membrane consisting of porous material and/or narrow tube(s);
one or more reactants contained in or added to said gaseous material being pumped that produce an exothermic or endothermic chemical reaction;
and a thermal path of lower resistance from the location of chemical reaction to the outlet side of said membrane than the inlet side in the case of exothermic reactants, or a path of lower resistance to the inlet side than the outlet side in the case of endothermic reactants

2. The apparatus of claim 1 wherein said reaction is an exothermic reaction that occurs on a catalyst surface that has lower thermal resistance to the outlet side of the thermal transpiration membrane than the inlet side

3. The apparatus of claim 1 wherein said reaction is an endothermic reaction that occurs on a catalyst surface that has lower thermal resistance to the inlet side of the thermal transpiration membrane than the outlet side

4. The apparatus of claim 1 wherein reactants in said gaseous material include hydrogen and/or hydrocarbon fuel and ambient air to produce an exothermic reaction

5. The apparatus of claim 2 or 3 wherein said catalyst surface contains platinum

6. The apparatus of claim 1 wherein the high pressure gas generated by said pump is expanded through a nozzle for the purpose of generating a larger momentum of the exhaust gas stream than of the inlet gas stream and thereby produces thrust to propel a vehicle traveling in air or in space

7. The apparatus of claim 1 wherein the material for said thermal transpiration membrane is silica aerogel

8. The apparatus of claim 1 incorporated into the center of a spiral-wound counter-current heat exchanger such that the reactants flow into one channel of said heat exchanger, through said pump, and reaction products exit through the other channel of said heat exchanger

9. A multistage thermal transpiration pump comprising:
a generally spiral counter-current heat exchanger;
a gas conduit passing through said heat exchanger oriented generally perpendicular to the channels of the heat exchanger;
thermal transpiration membranes within said conduit in regions of increasing temperature in the direction of flow through said conduit;
cross-flow heat exchangers having much larger diameter passages for the conduit gas than said thermal transpiration membranes in regions of decreasing temperature in the direction of flow through said conduit;
and thermal paths between said cross-flow heat exchangers and the material flowing through said spiral heat exchanger

10. A self-sustaining multistage thermal transpiration pump for gaseous material comprising:
the apparatus of claim 9;
a gas flow path between the outlet of said gas conduit and the inlet of said spiral counter-current heat exchanger;
and one or more heat sources located generally in the center of the spiral

11. The apparatus of claim 10 additionally comprising
one or more reactants contained in or added to said gaseous material that produce an exothermic chemical reaction;
and wherein said heat source(s) include an exothermic chemical reaction of one or more of the constituents of the gas flowing through said pump

12. The apparatus of claim 1
additionally comprising electrically conductive wires connected to said thermal guards;
said thermal transpiration membrane is a porous thermoelectric material;
and said thermal guards are electrically conductive

13. The apparatus of claim 12 wherein said thermoelectric material is bismuth

14. The apparatus of claim 12 wherein an electric current is applied through said thermoelectric material for the purpose of igniting a chemical reaction of one or more of the constituents of the gaseous material

15. The apparatus of claim 12 additionally comprising one or more additional transpiration stages placed in series with respect to the direction of gas flow and whose thicknesses are chosen as the performance of each stage over a particular temperature range for the purposes of combined pumping and thermoelectric power generation
